(19) United States
(12) Patent Application Publication
(10) Pub. No.: US 2017/0091099 A1
(43) Pub. Date: Mar. 30, 2017

(54) MEMORY CONTROLLER FOR MULTI-LEVEL SYSTEM MEMORY HAVING SECTORED CACHE

(71) Applicants: ZVIKA GREENFIELD, Kfar Sava (IL); ISRAEL DIAMAND, Aderet (IL)

(72) Inventors: ZVIKA GREENFIELD, Kfar Sava (IL); ISRAEL DIAMAND, Aderet (IL)

(21) Appl. No.: 14/865,525

(22) Filed: Sep. 25, 2015

(51) Int. Cl. G06F 12/08

(52) U.S. Cl. CPC G06F 12/0831; G06F 12/0811; G06F 12/0848; G06F 2212/283; G06F 2212/282

(57) ABSTRACT

An apparatus is described. The apparatus includes a memory controller to interface with a multi-level system memory. The multi-level system memory has a near memory level and a far memory level. The near memory level has a sectored cache to cache super lines having multiple cache lines as a single cacheable item. The memory controller has tracker circuitry to track status information of an old request super line and a new request super-line that compete for a same slot within the sectored cache, wherein, the status information includes an identification of which one of the old and new super-lines is currently cached in the sectored cache.

### FIELD OF INVENTION

The field of invention pertains generally to computing systems, and, more specifically, to a memory controller for a multi-level system memory having a sectored cache.

### BACKGROUND

Computing systems typically include system memory (or main memory) that contains data and program code of the software code that the system's processor(s) are currently executing. A pertinent bottleneck in many computer systems is the system memory. Here, as is understood in the art, a computing system operates by executing program code stored in system memory. The program code when executed reads and writes data from/to system memory. As such, system memory is heavily utilized with many program code and data reads as well as many data writes over the course of the computing system's operation. Finding ways to speed-up system memory is therefore a motivation of computing system engineers.

### FIGURES

A better understanding of the present invention can be obtained from the following detailed description in conjunction with the following drawings, in which:

FIG. 1 shows a computing system having a multi-level system memory;

FIGS. 2a through 2f show operation of a memory controller that tracks eviction and fill status of competing super-line pairs;

FIGS. 3a-c shows various scenarios of operation of the memory controller of FIGS. 2a through 2f;

FIG. 4 shows a methodology that can be performed by the memory controller of FIGS. 2a through 2f;

FIG. 5 shows an embodiment of a computing system.

### DETAILED DESCRIPTION

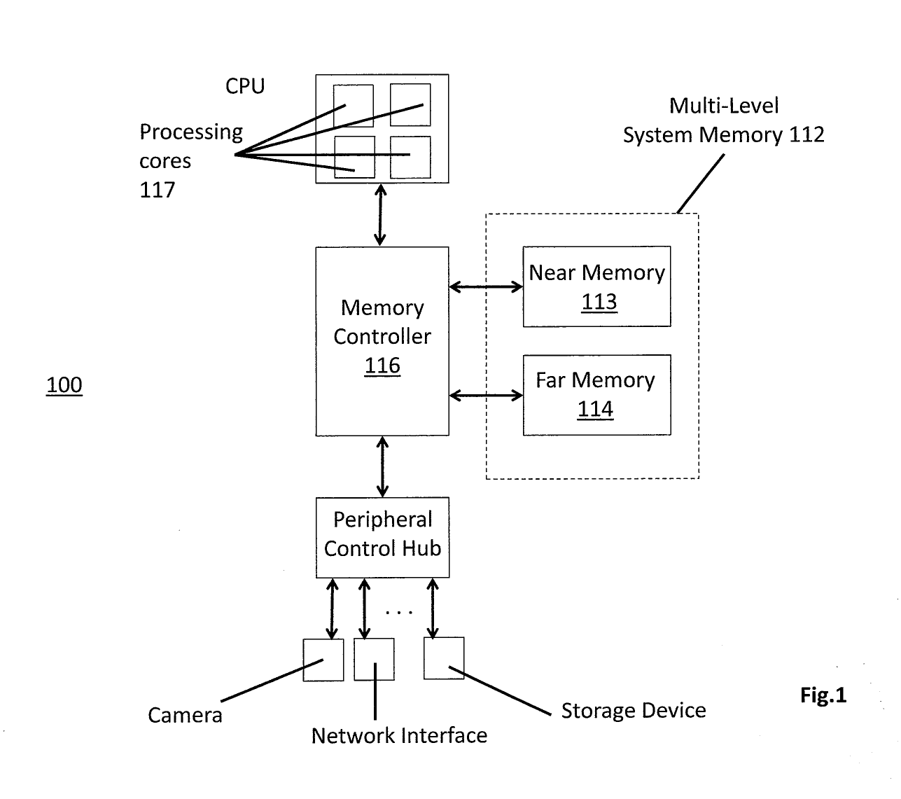

One of the ways to speed-up system memory without significantly increasing power consumption is to have a multi-level system memory. FIG. 1 shows an embodiment of a computing system 100 having a multi-tiered or multi-level system memory 112. According to various embodiments, a faster near memory 113 may be utilized as a memory side cache.

In the case where near memory 113 is used as a memory side cache, near memory 113 is used to store data items that are expected to be more frequently called upon by the computing system. The near memory cache 113 has lower access times than the lower tiered far memory 114 region. By storing the more frequently called upon items in near memory 113, the system memory will be observed as faster because the system will often read items that are being stored in faster near memory 113.

According to some embodiments, for example, the near memory 113 exhibits reduced access times by having a faster clock speed than the far memory 114. Here, the near memory 113 may be a faster, volatile system memory technology (e.g., high performance dynamic random access memory (DRAM)) or faster non volatile memory. By contrast, far memory 114 may be either a volatile memory technology implemented with a slower clock speed (e.g., a DRAM component that receives a slower clock) or, e.g., a non volatile memory technology that is inherently slower than volatile/DRAM memory or whatever technology is used for near memory.

For example, far memory 114 may be comprised of an emerging non volatile byte addressable random access memory technology such as, to name a few possibilities, a phase change based memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc.

Such emerging non volatile random access memories technologies typically have some combination of the following: 1) higher storage densities than DRAM (e.g., by being constructed in three-dimensional (3D) circuit structures (e.g., a crosspoint 3D circuit structure); 2) lower power consumption densities than DRAM (e.g., because they do not need refreshing); and/or 3) access latency that is slower than DRAM yet still faster than traditional non-volatile memory technologies such as FLASH. The later characteristic in particular permits an emerging non volatile memory technology to be used in a main system memory role rather than a traditional storage role (which is the traditional architectural location of non volatile storage).

Regardless of whether far memory 114 is composed of a volatile or non volatile memory technology, in various embodiments far memory 114 acts as a true system memory in that it supports finer grained data accesses (e.g., cache lines) rather than larger blocked based accesses associated with traditional, non volatile storage (e.g., solid state drive (SSD), hard disk drive (HDD)), and/or, otherwise acts as an (e.g., byte) addressable memory that the program code being executed by processor(s) of the CPU operate out of.

Because near memory 113 acts as a cache, near memory 113 may not have its own individual addressing space. Rather, only far memory 114 includes the individually addressable memory space of the computing system's main memory. In various embodiments near memory 113 truly acts as a cache for far memory 114 rather than acting a last level CPU cache (generally, a CPU level cache is able to keep cache lines across the entirety of system memory addressing space that is made available to the processing cores 117 that are integrated on a same semiconductor chip as the memory controller 116).

For example, in various embodiments, system memory is implemented with dual in-line memory module (DIMM) cards where a single DIMM card has both DRAM and (e.g., emerging) non volatile memory chips disposed in it. The DRAM chips effectively act as an on board cache for the non volatile memory chips on the DIMM card. Ideally, the more frequently accessed cache lines of any particular DIMM card will be found on that DIMM card's DRAM chips rather than its non volatile memory chips. Given that multiple DIMM cards are typically plugged into a working computing system and each DIMM card is only given a section of the system memory addresses made available to the processing cores 117 of the semiconductor chip that the DIMM cards are coupled to, the DRAM chips are acting as a cache for the non volatile memory that they share a DIMM card with rather than a last level CPU cache.

In other configurations DIMM cards having only DRAM chips may be plugged into a same system memory channel (e.g., a DDR channel) with DIMM cards having only non volatile system memory chips. Ideally, the more frequently used cache lines of the channel will be found in the DRAM DIMM cards rather than the non volatile memory DIMM cards. Thus, again, because there are typically multiple memory channels coupled to a same semiconductor chip having multiple processing cores, the DRAM chips are acting as a cache for the non volatile memory chips that they share a same channel with rather than as a last level CPU cache. Although the above example referred to packaging solutions that included DIMM cards, it is pertinent to note that this is just one example and other embodiments may use other packaging solutions (e.g., stacked chip technology, one or more DRAM and phase change memories integrated on a same semiconductor die or at least within a same package as the processing core(s), etc.).

In yet other embodiments, near memory 113 may act as a CPU level cache.

The architecture of the near memory cache 113 may also vary from embodiment. According to one approach, the near memory cache 113 is implemented as a direct mapped cache in which multiple system memory addresses map to one cache line slot in near memory 113. Other embodiments may implement other types of cache structures (e.g., set associative, etc.). Regardless of the specific cache architecture, different cache lines may compete for the same cache resources in near memory 113.

For example, in the case of a direct mapped cache, when requests for two or more cache lines whose respective addresses map to the same near memory 113 cache line slot are concurrently received by the memory controller 116, the memory controller 116 will keep one of the cache lines in near memory cache 113 and cause the other cache line to be kept in far memory 114.

Whenever a request for a cache line is received by the memory controller 216, the memory controller first checks for the cache line in near memory cache 113. If the result is a cache hit, the memory controller 113 services the request from the version of the cache line in near memory 113 (in the case of a read request, the version of the cache line in near memory cache is forwarded to the requestor; in the case of a write, the version of the cache line in near memory cache is written over and kept in the near memory cache). In the case of a cache miss, for both read and write requests, the cache line that is targeted by the request is called up from far memory 114 and stored in near memory cache 113. In order to make room for the new cache line in near memory cache 113, another cache line that competes with the targeted cache line is evicted from near memory cache 113 and sent to far memory 114.

Data consistency problems may arise if care is not taken handling cache lines while in the process of evicting an old cache line from near memory 113 to far memory and filling the space created in near memory cache 113 by the eviction of the old cache line with the new cache line whose read or write request just suffered a cache miss. For example, if the evicted cache line is dirty (meaning it contains the most recent, up to date version of the cache line's data) and a write request is received for the evicted cache line before it is actually written to far memory 114, the memory controller 116 needs to take appropriate action to make sure the dirty cache line is updated with the new data.

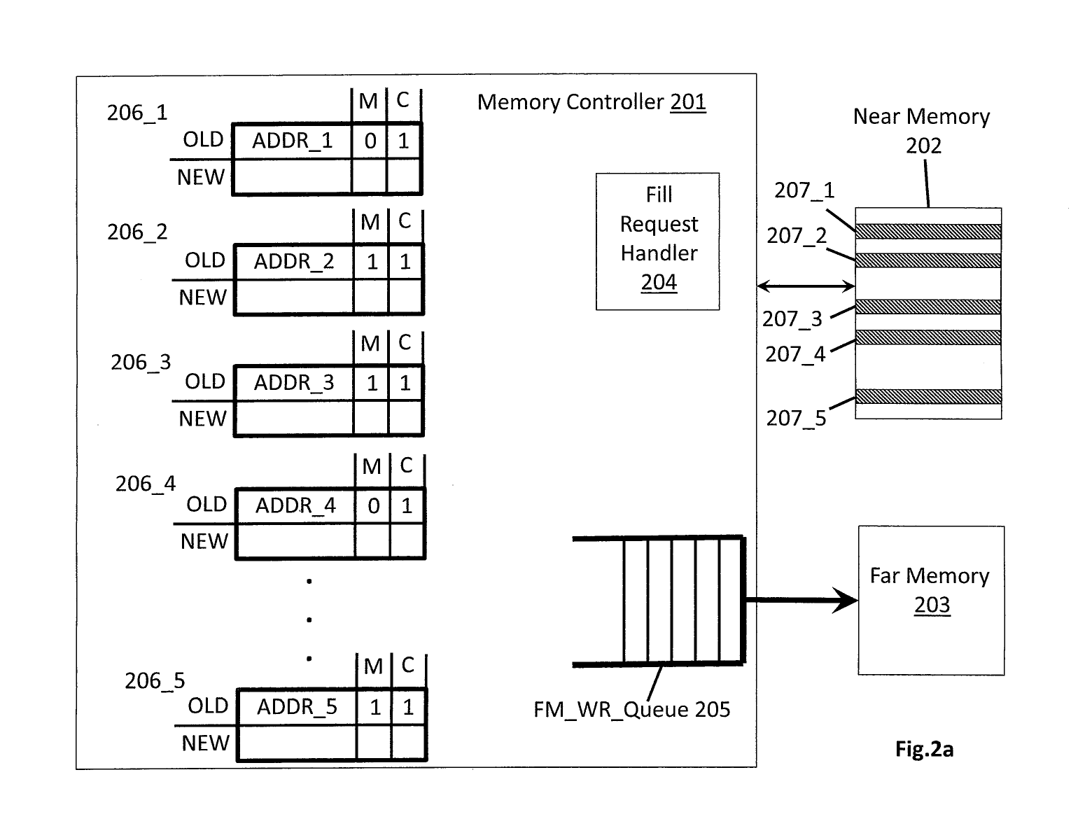

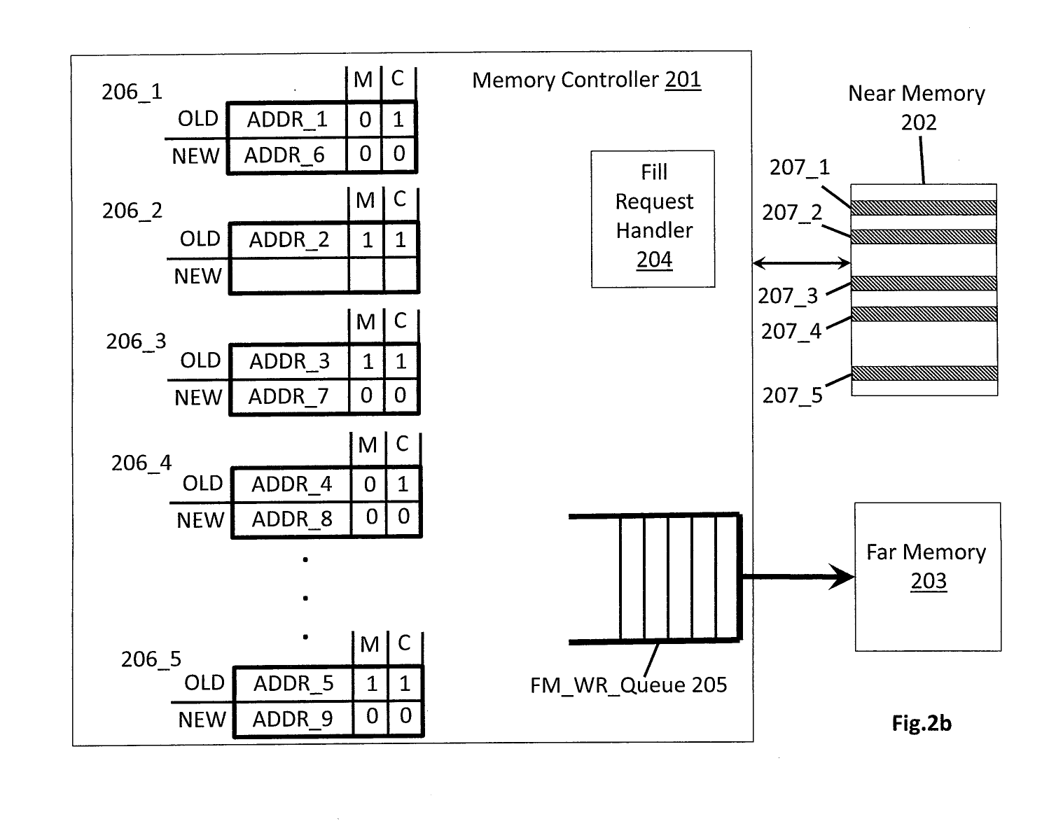

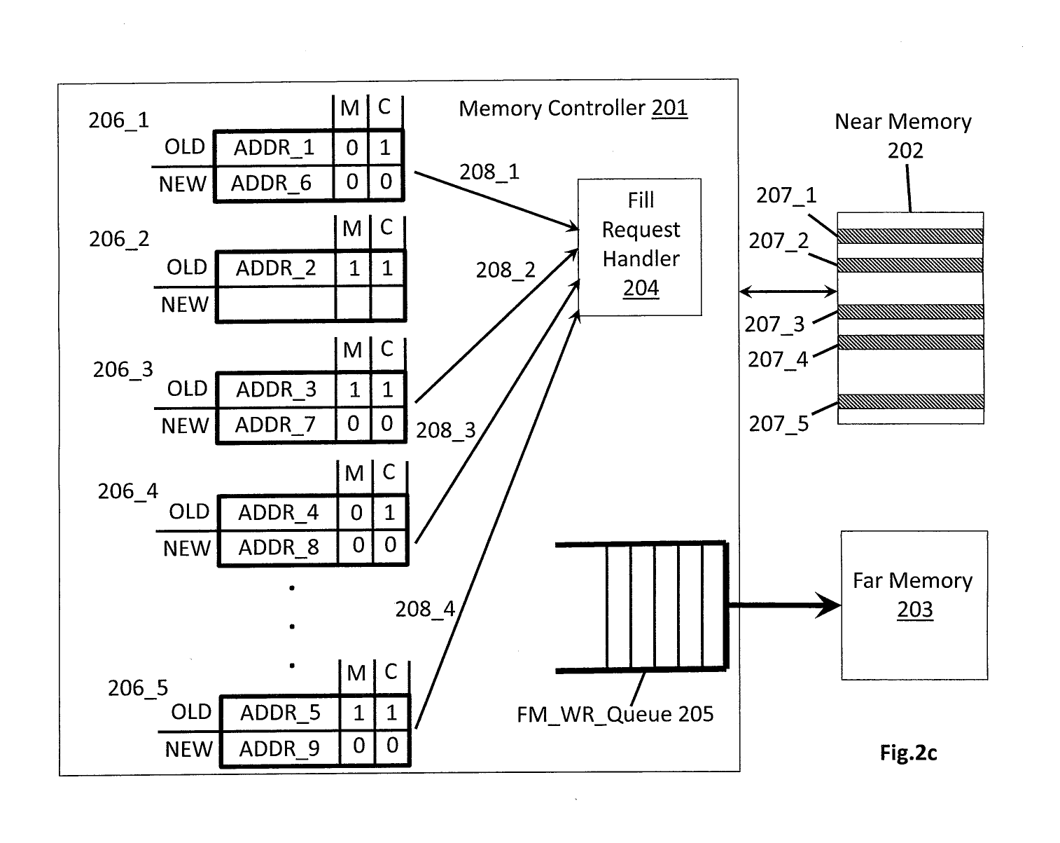

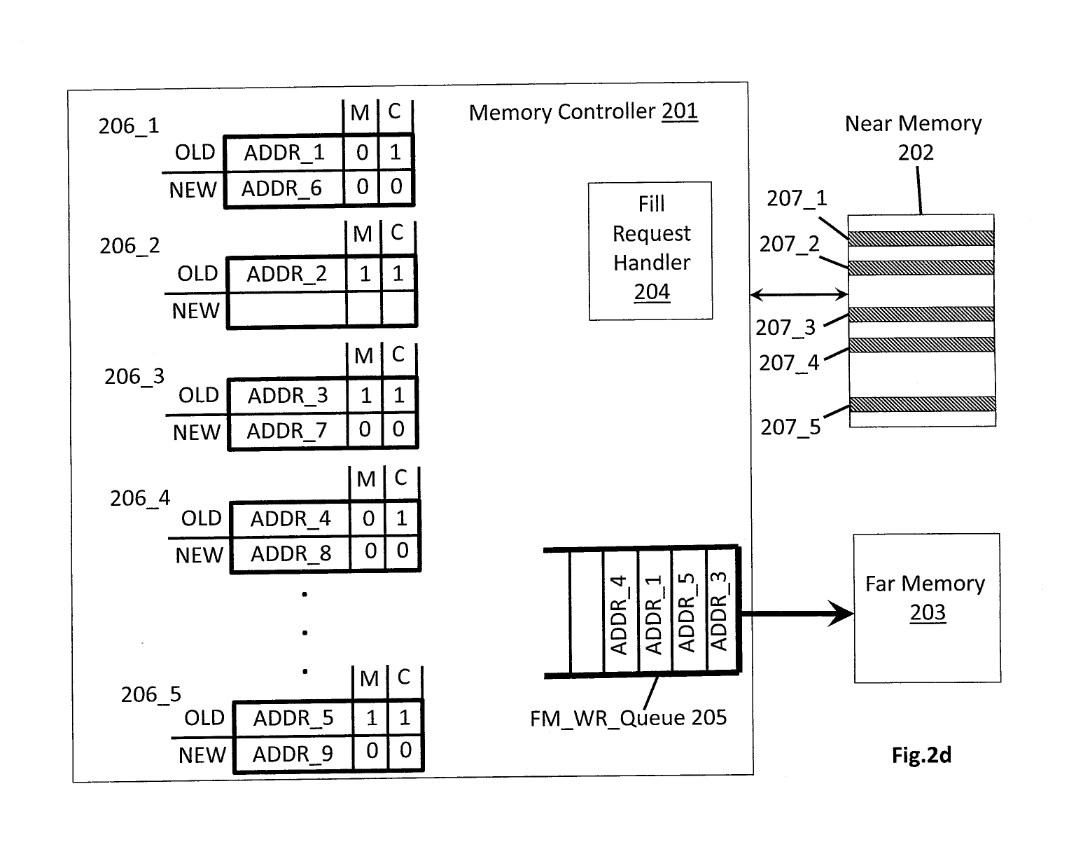

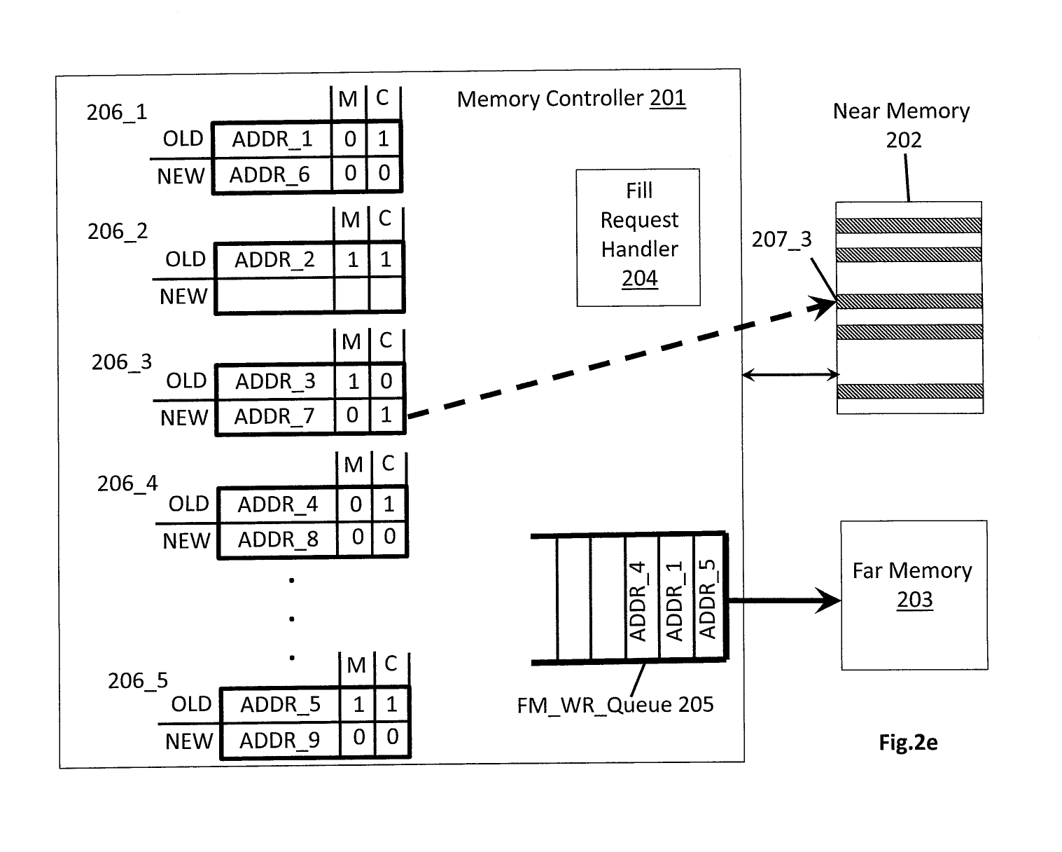

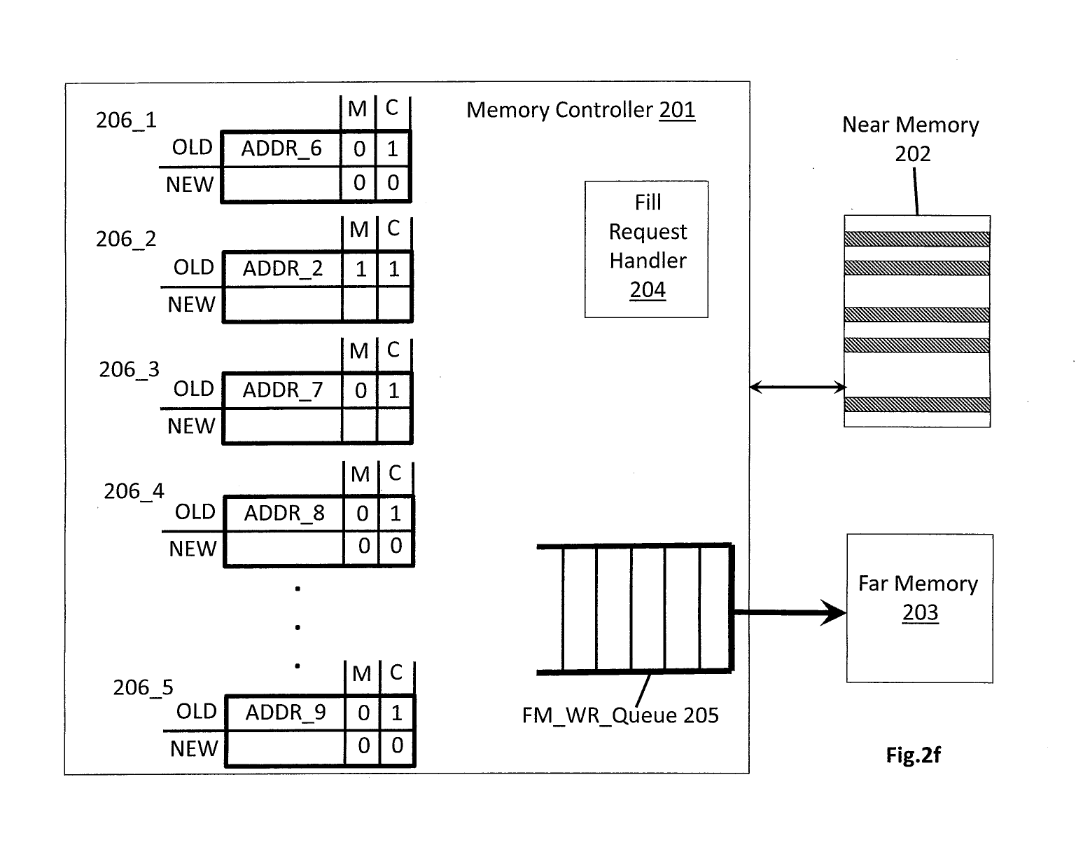

FIGS. 2a through 2f describe operation of an improved memory controller 201 that is able to keep track of both the actual eviction process for old cache lines being evicted, and, the actual filling process of new cache lines being inserted into near memory cache 202.

Before beginning the discussion of FIGS. 2a through 2f, however, it is pertinent to point out that the solution they describe may be particularly useful in the case of a sectored cache that caches super-lines composed of multiple cache lines. As is known in the art, a cache line typically includes multiple individually addressable (e.g., 32 bit or 64 bit) data or instruction items. For example, a typical cache line may be 64 bytes and contain eight 64 bit data units. The size of a cache line (the number of data/instruction items it contains) is typically coextensive with the width of the internal caches of the corresponding CPU core(s). By contrast, a super-line may consist, for example, of sixteen cache lines (=16×64 bytes=1024 bytes of information). In the case of a sectored cache that caches super-lines, a single read cache hit results in multiple (e.g., sixteen) cache lines being forwarded to the CPU.

The data consistency problems mentioned just above are especially more likely to occur in the case of a sectored cache that moves entire super-lines between near memory and far memory (as opposed to a more traditional, nominally sized cache lines). For example, with the much larger size of a super-line, there is more data to move from near memory to far memory in the case of an eviction from near memory cache to far memory. This may result in more propagation delay, e.g., physically reading all of the data from near memory and then forwarding this data within the memory controller to a far memory interface. Additionally, again with the expansive size of the super line, there is a greater chance that an incoming write request will target a cache line within the super-line. Thus the likelihood that an incoming write request will target a cache line as it is in the process of moving between near memory and far memory becomes a more likely event in the case of a super-line and a sectored cache.

As such, the discussion below will generally refer to a super-line although the reader should understand the approach of FIGS. 2a through 2f can also be applied to smaller data units (e.g., nominally sized cache lines).

As observed in FIG. 2a, the memory controller 201 includes a plurality of eviction/filling state tracker circuits 206_1 through 206_5 for super-line pairs having an eviction/filling relationship (i.e., the filling super-line consumes the space in near memory 202 made available by the super-line being evicted). For simplicity, only five such tracker circuits are depicted. In various embodiments, the number of such tracker circuits may be less than the size of the near memory cache but large enough to concurrently track large numbers of super-lines. For example, there may exist a number of tracker circuits equal to 20% of the size of the near memory cache, and, the tracker circuits are reused five times over to fully process the entire cache.

Each tracker circuit 206 includes register space to hold state information for both the evicted and the filling super-lines. The state information may be kept, e.g., in memory such as dedicated (non cache) part of near memory 202. In an embodiment, the state information identifies a particular super-line by its address and two items of meta data that indicate whether the particular super-line is still formally residing in near memory cache 203, and, whether the particular super-line is in a modified state (M). Note that a single address may be used to identify a particular super-line (as suggested in FIG. 2a), or, depending on implementation, a single entry in tracker circuit may individually identify the address of each super-line in the corresponding super-line. Like-wise the meta data may be present only for the entire super-line, or, may be present for each super-line in the super-line. For simplicity, the following discussion assumes one address and meta-data instance per super-line.

As is known in the art, a super-line in the M state is essentially a “dirty” super-line in that it holds the most recent, up to date data for the super-line. As will be described more clearly below, a pertinent feature of the memory controller 201 of FIG. 2a is that a new super-line is not permitted to fill the near memory 202 cache space created by an evicted super-line until the evicted super-line is actually evicted from the memory controller 201 and written into far memory 203. Here, note that movement of data may therefore include moving a copy of the data while the data remains in its original location.

FIG. 2a shows the state of a memory controller 201 for five near memory sectored cache slots 207_1 through 207_5 and the corresponding tracker circuit 206_1 through 206_5 for each slot (i.e., tracker circuit 206_1 tracks the evicted/fill pairs for slot 207_1, tracker circuit 206_2 tracks the evicted/fill pairs for slot 207_2, etc.). For simplicity, FIG. 2a shows a memory controller state where no competing super-line requests have been received for sectored cache slots 207_1 through 207_5. As such, each tracker circuit 206_1 through 206_5 only shows an “old” super-line (no “new” competing super-lines have been received yet). Because each old super-line is presently residing within near memory cache 202 in its respective slot, each of the old super-lines has a corresponding “C” bit set. Here, for any entry in a tracker circuit, the C bit indicates whether or not the corresponding super-line is physically in near memory cache 202. Also observed in FIG. 2a is that some of the old super-lines are dirty (M bit is set) whereas other super-lines are not dirty (M bit is not set).

FIG. 2b shows a moment in time after the situation of FIG. 2a in which four of the five super-line slots in the sectored near memory cache have been targeted by a new memory access request and the result was a cache miss resulting in four pairs of old and new super-lines. Here, slot 207_2, which corresponds to tracker circuit 206_2, has either not had any new memory access requests, or, has had a new memory access request that targeted the old super-line having address ADDR_2 (i.e., a cache hit resulted). Regardless, there is no new super-line to fill slot 207_2 and evict the super-line having address ADDR_2.

In an embodiment, a tag array (not shown) resides within a memory region (not depicted) of the memory controller 201 to indicate whether or not a cache hit has resulted for any particular super-line. A tag array essentially includes an entry for each slot in the sectored near memory cache and keeps the “tag” (e.g., upper) address bits for the particular super-line that is presently occupying the slot in the sectored near memory cache. For each incoming request, hashing or lookup circuitry (also not shown) associated with the tag array respectively performs a hash or lookup operation to map the address of the request to the particular entry in the tag array that the address maps to. If the tag held in the entry of the tag array matches the corresponding tag of the request the result is a cache hit. Otherwise the result is a cache miss. Note that, in an embodiment, the “old” entries in the state tracker circuits 206 may mimic the address tag information in the tag array. If the number of state tracker circuits is less than the number of slots in the cache, information from the tag array is used to “fill” the “old” entries of the state tracker circuits 206.

Continuing then with the present example, in contrast to slot 207_2, each of the other slots 207_1 and 207_3 through 207_5 have been newly targeted by a memory access request that resulted in a cache miss. As such, each of slots 207_1 and 207_3 through 207_5 have a corresponding old super-line that needs to be evicted and a new super-line that will fill the space created in near memory cache 202 by the evicted super-line. No actual eviction/filling activity has taken place as of FIG. 2b. As such, the old super-lines of FIG. 2b maintain the same state that they had in FIG. 2a (C bit is set to TRUE). Similarly, each of the new super-lines have not yet been actually written into near memory 202. As such, each of the new super-lines have their C bit set to FALSE. Each new super-line also is not dirty and therefore does not have its M bit set.

As observed in FIG. 2c, logic circuitry associated with each of the request tracker circuits 206_1 and 206_3 through 206_5 having an old and new super-line pair generate a fill request 208_1 through 208_4 to a fill request handler circuit 204. Here, the sending of a fill request by a tracker circuit is triggered by the logic circuitry of a tracker circuit recognizing it has an old and new super-line pair.

As observed in FIG. 2d, the fill request handler circuit 204 responds to the fill requests 208_1 through 208_4 by prioritizing the eviction of super-lines in the M state over super-lines that are not in the M state. That is, as observed from FIGS. 2a through 2c, the super-lines having address ADDR_3 and ADDR_5 were in the M state while the super-lines having addresses ADDR_1 and ADDR_4 were not in the M state. As observed in FIG. 2d, the super-lines having addresses ADDR_3 and ADDR_5 have been placed ahead of the super-lines having addresses ADDR_1 and ADDR_4 in the far memory write queue 205. As a consequence, the super-lines having addresses ADDR_3 and ADDR_5 will be evicted from the memory controller 201 into far memory 203 before the super-lines having addresses ADDR_1 and ADDR_4. In various embodiments, as part of the placement of super-lines into the queue 205, the super lines within the M state may themselves be further prioritized according to any additional information (e.g., prioritizing super-lines that are less likely to soon be targeted by a request before super-lines that are more likely to soon be targeted by a request). Super-lines not within the M state may also be further prioritized to determine their order of entry in the queue according to a same or other basis.

Note that because all four super-lines being evicted have not actually been evicted yet (they are still on the host side in the memory controller 201 and have not yet been written to far memory 203) their corresponding tracker entry still shows each super-line in the C state. That is, each of these super-lines still has a version of itself resident in its corresponding slot in near memory cache 202.

Note that because super-lines ADDR_3 and ADDR_5 are dirty they should be evicted into far memory 203. Whether or not the super-lines ADDR_1 and ADDR_4 should actually be evicted depends on implementation. Specifically, super-lines that are not dirty (such as the super-lines having addresses ADDR_1 and ADDR_4) need only actually be evicted into far memory 203 if there does not exist a copy of them already in far memory 203. Here, systems may differ as between the exact content of the near memory cache 202 and far memory 203. Some systems may keep a copy in far memory 203 of any super-line in near memory cache 202. For these systems, it is not necessary to write back to far memory 203 an evicted super-line that is not in the M state. Other systems, however, may not keep a copy in far memory 203 of a super-line that is cached in near memory 202. These systems, by contrast, should write back “clean” (non M state) evicted super-lines to far memory 203 as observed in FIG. 2d.

FIG. 2e shows the state of the memory controller 201 after the super-line having address ADDR_3 has been physically evicted from the host side and written to far memory 203. Here, after the eviction of the super-line, the fill request handler 204 permits the new super-line having address ADDR_7 to physically replace the old super-line having ADDR_3 in slot 207_3 of near memory cache 202. After the replacement, the corresponding tracker circuit 206_3 flips the state of the C bit for the two entries. That is, with the new super-line having been physically written into in near memory 202, the new super-line has its C bit set to TRUE to indicate the super-line having address ADDR_7 is now in near memory cache. Similarly, the tag array may now be updated to include the tag of ADDR_7 for slot 207_3. Finally, the entry for the old super-line has its C bit set to FALSE to indicate it is no longer in near memory cache 202.

FIG. 2f shows the state of the memory controller 201 after all old super-lines requiring eviction have been evicted and replaced in near memory cache with their corresponding new replacement. Here, the new replacement super-lines are given old status in the tracker circuit which may set up another sequence similar to FIGS. 2a through 2e for a next round of memory access requests.

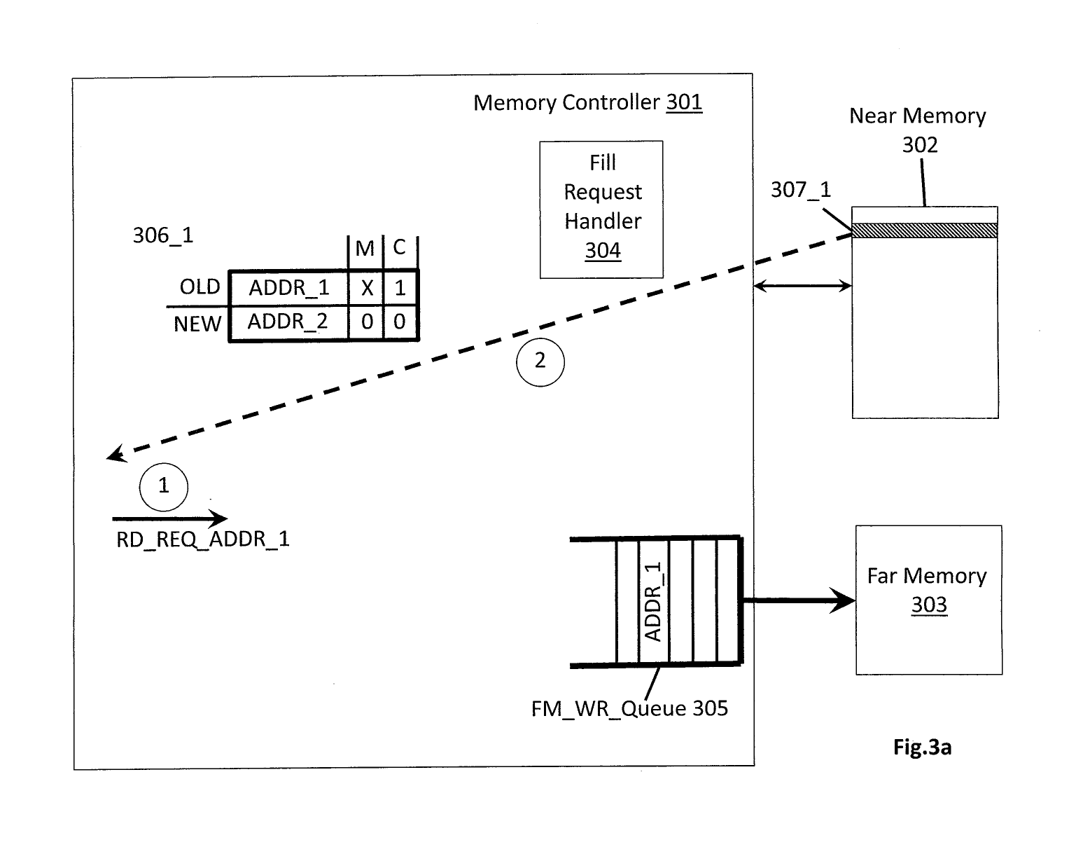

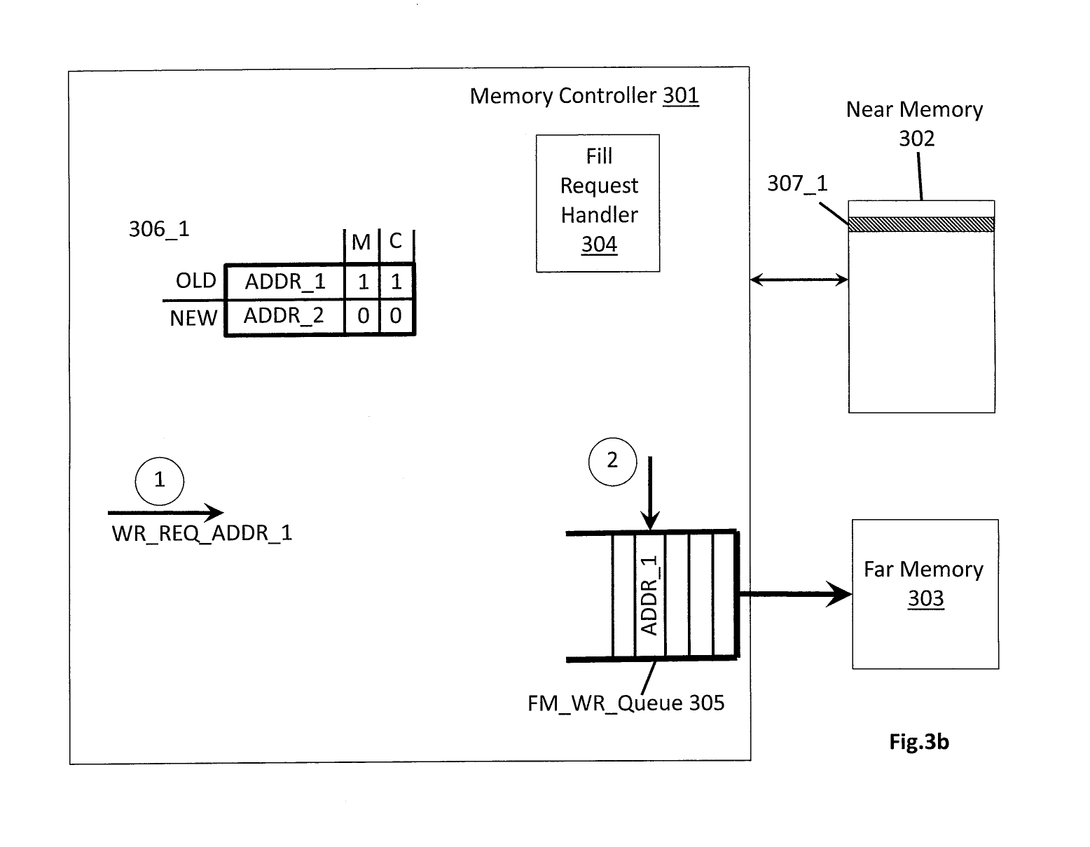

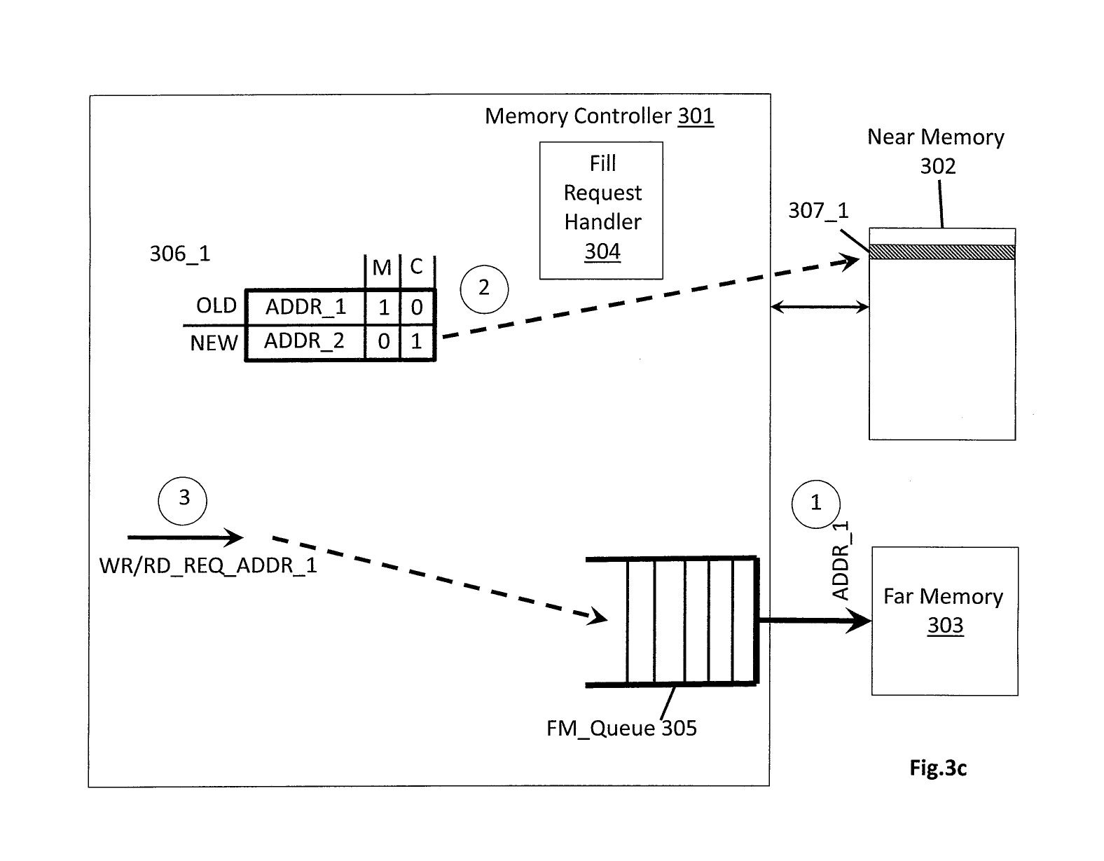

FIGS. 3a and 3b show a first set of scenarios that may transpire while a super-line is being evicted. FIG. 3a shows a memory controller state where an old super-line is being evicted but has not actually been evicted yet (it is sitting in the far memory write queue 305 waiting to be written to far memory 303). If in this state a read request is received 1 for the old super-line, the read request can be serviced by reading 2 the old super-line from near memory cache 302. Here, the memory controller can refer to the tracker circuit 306_1 which indicates that the old super-line (having address ADDR_1) is still physically resident in near memory cache because its C bit is still set to TRUE. As such the read request can be directed to near memory 302. The scenario of FIG. 3a does not care if the evicted super-line is in the M state or not.

FIG. 3b shows the same situation as with FIG. 3a except that the newly received request 1 for the super-line being evicted is a write request. As observed in FIG. 3b, the write request may be serviced by writing 2 to the super-line directly in the outbound write queue 305. Alternatively, the write request itself may simply be entered in the outbound queue 305 so that the new data reflected in the write request eventually overwrites the super-line in far memory 303 (the new write request follows the eviction write request in FIFO order). The scenario of FIG. 3b explicitly shows the super-line being evicted as being in the M state. If the super-line were not in the M state and a copy of itself existed in far memory 303, the new write request could simply be added to the write queue 305 even if no evicted version of the super-line were written to far memory.

FIG. 3c shows the situation of FIG. 3b after the evicted super-line is physically written 1 into far memory 303. After the super-line is physically written 1 into far memory 303, the fill request handler 304 writes 2 the new super-line into near memory and flips the C state of the respective super-line entries (C state of old super-line flips from TRUE to FALSE and C state of new super-line flips from FALSE to TRUE). If a subsequent request is received for the old super-line, whether read or write, it is simply entered into the far memory outbound queue 305 because the C state for the old super-line indicates that the old super-line is no longer in near memory.

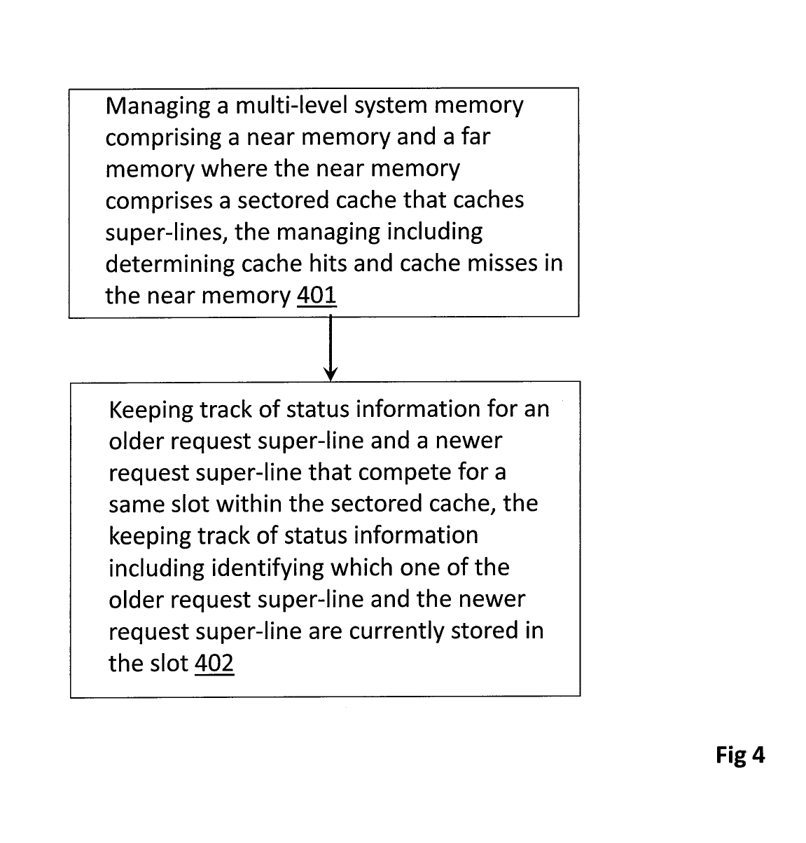

FIG. 4 shows a methodology performed by a memory controller described herein. As observed in FIG. 4, the method includes managing a multi-level system memory comprising a near memory and a far memory where the near memory comprises a sectored cache that caches super-lines and where the managing includes determining cache hits and cache misses in the near memory 401. The method also includes keeping track 402 of status information for an older request super-line and a newer request super-line that compete for a same slot within the sectored cache, the keeping track of status information including identifying which one of the older request super-line and the newer request super-line are currently stored in the slot.

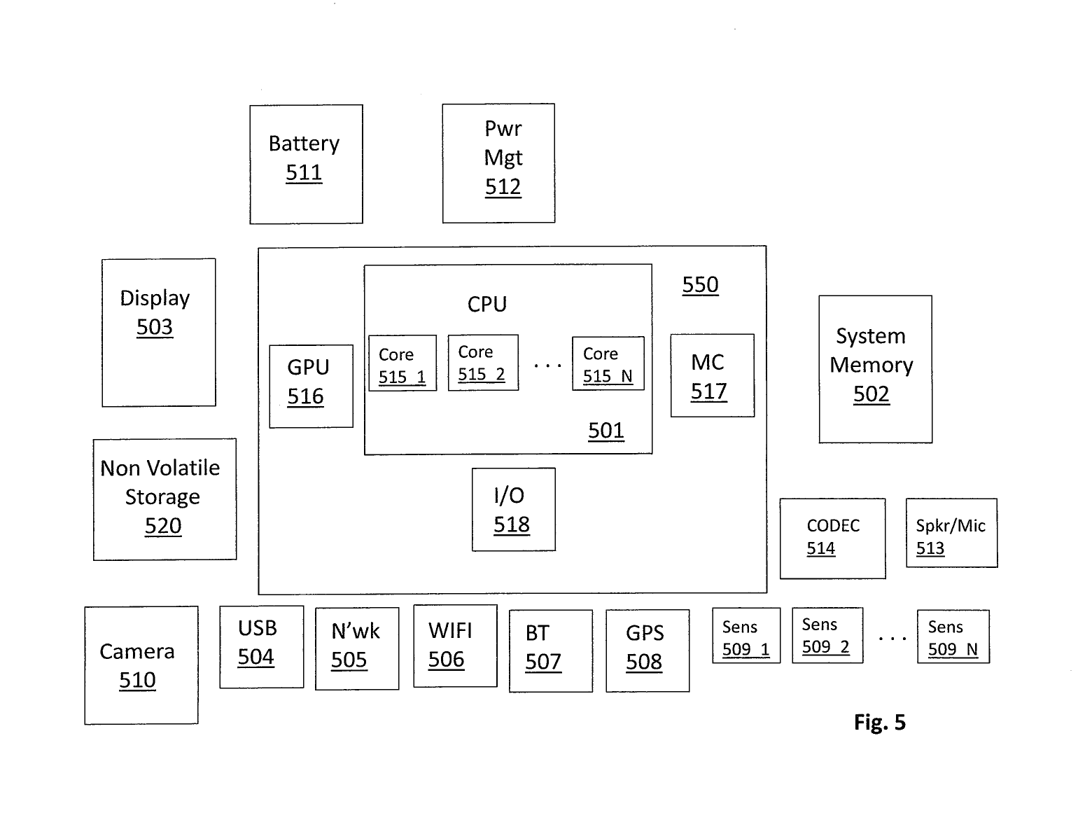

FIG. 5 shows a depiction of an exemplary computing system 500 such as a personal computing system (e.g., desktop or laptop) or a mobile or handheld computing system such as a tablet device or smartphone, or, a larger computing system such as a server computing system. As observed in FIG. 5, the basic computing system may include a central processing unit 501 (which may include, e.g., a plurality of general purpose processing cores and a main memory controller disposed on an applications processor or multi-core processor), system memory 502, a display 503 (e.g., touchscreen, flat-panel), a local wired point-to-point link (e.g., USB) interface 04, various network I/O functions 505 (such as an Ethernet interface and/or cellular modem subsystem), a wireless local area network (e.g., WiFi) interface 506, a wireless point-to-point link (e.g., Bluetooth) interface 507 and a Global Positioning System interface 508, various sensors 509_1 through 509_N (e.g., one or more of a gyroscope, an accelerometer, a magnetometer, a temperature sensor, a pressure sensor, a humidity sensor, etc.), a camera 510, a battery 511, a power management control unit 512, a speaker and microphone 513 and an audio coder/decoder 514.

An applications processor or multi-core processor 550 may include one or more general purpose processing cores 515 within its CPU 501, one or more graphical processing units 516, a memory management function 517 (e.g., a memory controller) and an I/O control function 518. The general purpose processing cores 515 typically execute the operating system and application software of the computing system. The graphics processing units 516 typically execute graphics intensive functions to, e.g., generate graphics information that is presented on the display 503. The memory control function 517 interfaces with the system memory 502. The system memory 502 may be a multi-level system memory such as the multi-level system memory discussed at length above. The memory controller may include tracker circuitry as described at length above. During operation, data and/or instructions are typically transferred between deeper non volatile (e.g.,“disk”) storage 520 and system memory 502. The power management control unit 512 generally controls the power consumption of the system 500.

Each of the touchscreen display 503, the communication interfaces 504-507, the GPS interface 508, the sensors 509, the camera 510, and the speaker/microphone codec 513, 514 all can be viewed as various forms of I/O (input and/or output) relative to the overall computing system including, where appropriate, an integrated peripheral device as well (e.g., the camera 510). Depending on implementation, various ones of these I/O components may be integrated on the applications processor/multi-core processor 550 or may be located off the die or outside the package of the applications processor/multi-core processor 550.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a memory controller to interface with a multi-level system memory comprising a near memory level and a far memory level, said near memory level comprising a sectored cache to cache super lines comprising multiple cache lines as a single cacheable item, said memory controller comprising tracker circuitry to track status information of an old request super line and a new request super-line that compete for a same slot within said sectored cache, wherein said status includes an identification of which one of the old and new super-lines is currently cached in the sectored cache.

2. The apparatus of claim 1 wherein the status further identifies whether a cached super-line is in a modified state.

3. The apparatus of claim 1 wherein the memory controller further comprises fill request handler circuitry, the fill request handler circuitry to receive a request from the tracker circuitry after the tracker circuitry recognizes that the new request super-line competes with the old request super line for the slot in the sectored cache.

4. The apparatus of claim 3 wherein the fill request handler circuitry causes the old request super line to be read from the sectored cache and placed into an outbound far memory FIFO.

5. The apparatus of claim 4 wherein the fill request handler places super-lines being evicted having a modified state ahead in the FIFO of super-lines being evicted that do not have a modified state.

6. The apparatus of claim 1 wherein, upon receipt of a read request for the old request super-line, the memory controller will check the tracker circuitry for the status of the old request cache line, and, if the old request cache line is currently cached in the sectored cache, the memory controller will service the read request from the sectored cache.

7. The apparatus of claim 1 wherein, upon receipt of a write request for the old request super-line, the memory controller will check the tracker circuitry for the status of the old request super-line, and, if the old request super-line is currently cached in the sectored cache, the memory controller will service the write request by writing to the old request super-line before it is evicted from the memory controller.

8. The apparatus of claim 1 wherein, upon receipt of a read or write request for the old request super-line, the memory controller will check the tracker circuitry for the status of the old request super-line, and, if the old request super-line is not currently cached in the sectored cache, the memory controller will service the read or write request by entering the read or write request in an outbound far memory FIFO queue.

9. A method, comprising:
managing a multi-level system memory comprising a near memory and a far memory where the near memory comprises a sectored cache that caches super-lines, the managing including determining cache hits and cache misses in the near memory;
keeping track of status information for an older request super-line and a newer request super-line that compete for a same slot within said sectored cache, said keeping track of status information including identifying which one of said older request super-line and said newer request super-line are currently stored in the slot.

10. The method of claim 9 wherein said status information also identifies whether said older request super-line is modified.

11. The method of claim 10 wherein said method includes moving said older request super-line while said older request super-line is the process of being evicted to said far memory ahead of other super-lines being evicted that are not in a modified state.

12. The method of claim 9 wherein said method comprises:
receiving a read request for said older request super-line before said older request super-line has been written to said far memory;
referring to said status information to understand that said older request super-line is currently within sectored cache; and,
servicing said read request from said sectored cache.

13. The method of claim 9 wherein said method comprises:
receiving a write request for said older request super-line before said older request super-line has been written to said far memory;
referring to said status information to understand that said older request super-line is currently within said sectored cache; and,
servicing said write request by writing to said older request super-line before said older request super-line is written to said far memory.

14. The method of claim 9 wherein said method comprises:
receiving a read or write request for said older request super-line after said older request super-line has been written to said far memory;
referring to said status information to understand that said older request super-line is no longer within said sectored cache; and,
servicing said read or write request by forwarding said read or write request to said far memory.

15. An apparatus, comprising:
a multi-level system memory comprising a near memory level and a far memory level, said near memory level comprising a sectored cache to cache super lines comprising multiple cache lines as a single cacheable item
a memory controller between the one or more processing cores and the networking interface, the memory controller to interface with the multi-level system memory, said memory controller comprising tracker circuitry to track status information of old request and new request super-lines that compete for a same slot within said sectored cache, wherein said status includes an identification of which one of the old and new super-lines is currently cached in the sectored cache.

16. The apparatus of claim 15 wherein the status further identifies whether a cached super-line is in a modified state.

17. The apparatus of claim 15 wherein the memory controller further comprises fill request handler circuitry, the fill request handler circuitry to receive a request from the tracker circuitry after the tracker circuitry recognizes that the new request super-line competes with the old request super line for the slot in the sectored cache.

18. The apparatus of claim 15 wherein, upon receipt of a read request for the old request super-line, the memory controller will check the tracker circuitry for the status of the old request cache line, and, if the old request cache line is currently cached in the sectored cache, the memory controller will service the read request from the sectored cache.

19. The apparatus of claim 15 wherein, upon receipt of a write request for the old request super-line, the memory controller will check the tracker circuitry for the status of the old request super-line, and, if the old request super-line is currently cached in the sectored cache, the memory controller will service the write request by writing to the old request super-line before it is evicted from the memory controller.

20. The apparatus of claim 15 wherein, upon receipt of a read or write request for the old request super-line, the memory controller will check the tracker circuitry for the status of the old request super-line, and, if the old request super-line is not currently cached in the sectored cache, the memory controller will service the read or write request by entering the read or write request in an outbound far memory FIFO queue.

21. The apparatus of claim 15,
at least one processor communicatively coupled to the memory controller and
a network interface communicatively coupled to the at least one processor.

22. The apparatus of claim 21 comprising:
a display communicatively coupled to the at least one processor.
